(19) United States
(12) Patent Application Publication
(10) Pub. No.: US 2004/0054762 A1
(43) Pub. Date: Mar. 18, 2004

(54) Distribution of operational instructions for networked devices

(76) Inventors: Travis J. Parry, Boise, ID (US); Jose L. Cervantes, Meridian, ID (US); George Kerby, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/245,886

(22) Filed: Sep. 16, 2002

(51) Int. Cl. G06F 15/177; G06F 9/445

(52) U.S. Cl. 709/221; 717/178

(57) ABSTRACT

In certain described implementations, a networked device may be configured to perform multiple actions to distribute operational instructions. These actions may include receiving information that is related to operational instructions for the networked device, procuring a file that has installable operational instructions responsive to the received information, and installing the file to an operational instructions space of the networked device. In an exemplary described networked device, the following may be included: an operational instructions space, where the operational instructions space is capable of storing operational instructions; a communication unit, where the communication unit is capable of receiving information that is related to new operational instructions for the networked device; and a distribution unit, where the distribution unit is coupled to the communication unit and is capable of receiving new operational instructions from the communication unit and providing the new operational instructions to the operational instructions space.

### TECHNICAL FIELD

This disclosure relates in general to the field of networked devices, and in particular, by way of example but not limitation, to distribution of operational instructions of such networked devices to such networked devices.

### BACKGROUND

Printers, other imaging appliances, and networked devices in general have become ubiquitous in society. In fact, networked devices are increasingly utilized in commercial, educational, and entertainment environments by people and entities with differing needs and in various situations. For example, such networked devices are used by groups in businesses and by individuals in homes, and they are frequently connected to networks such as intranets and/or the Internet. While in operation, these networked devices rely on instructions to accomplish their designated tasks. Operational instructions, at least in part, therefore enable networked devices to achieve their designated tasks, such as printing, copying, scanning, faxing, and so forth. Examples of operational instructions include firmware and translators. Thus, firmware and translators provide instructions that enable networked devices to operate.

### SUMMARY

Apparatuses, methods, systems, and arrangements facilitate the distribution of operational instructions for networked devices. In certain described implementations, a networked device may be configured to perform multiple actions. These actions may include receiving information that is related to operational instructions for the networked device, procuring a file that has installable operational instructions responsive to the received information, and installing the file to an operational instructions space of the networked device. In an exemplary described networked device, the following may be included: an operational instructions space, where the operational instructions space is capable of storing operational instructions of the networked device; a communication unit, where the communication unit is capable of receiving information that is related to new operational instructions for the networked device from an external source; and a distribution unit, where the distribution unit is coupled to the communication unit and is capable of receiving new operational instructions from the communication unit and providing the new operational instructions to the operational instructions space.

### BRIEF DESCRIPTION OF THE DRAWINGS

In the Drawings, like numerals are used for like and/or corresponding features, aspects, and components of the various FIGS. 1A-4D.

FIG. 1A illustrates a networked device in an exemplary environment with exemplary links to external communication points.

FIG. 1B illustrates a networked device that has exemplary instructions.

FIG. 2 illustrates an exemplary (e.g., multifunction) networked device showing various exemplary logical blocks and components.

FIG. 3 illustrates an exemplary networked device having an operational instructions distribution capability.

FIG. 3A illustrates an exemplary networked device having an operational instructions distribution capability via e-mail.

FIG. 3B illustrates an exemplary networked device having an operational instructions distribution capability via a reference to a non-local source.

FIG. 3C illustrates an exemplary networked device having an operational instructions distribution capability via a reference to a local source.

FIG. 3D illustrates an exemplary networked device having an operational instructions distribution capability via receptive file transfer under a file transfer protocol (FTP).

FIG. 4 illustrates an exemplary method in flowchart form for distributing operational instructions to a networked device.

FIG. 4A illustrates an exemplary method in flowchart form for distributing operational instructions to a networked device via e-mail.

FIG. 4B illustrates an exemplary method in flowchart form for distributing operational instructions to a networked device via non-local reference.

FIG. 4BB illustrates another exemplary method in flowchart form for distributing operational instructions to a networked device via non-local reference.

FIG. 4C illustrates an exemplary method in flowchart form for distributing operational instructions to a networked device via local reference.

FIG. 4D illustrates an exemplary method in flowchart form for distributing operational instructions to a networked device via receptive file transfer under an FTP.

### DETAILED DESCRIPTION

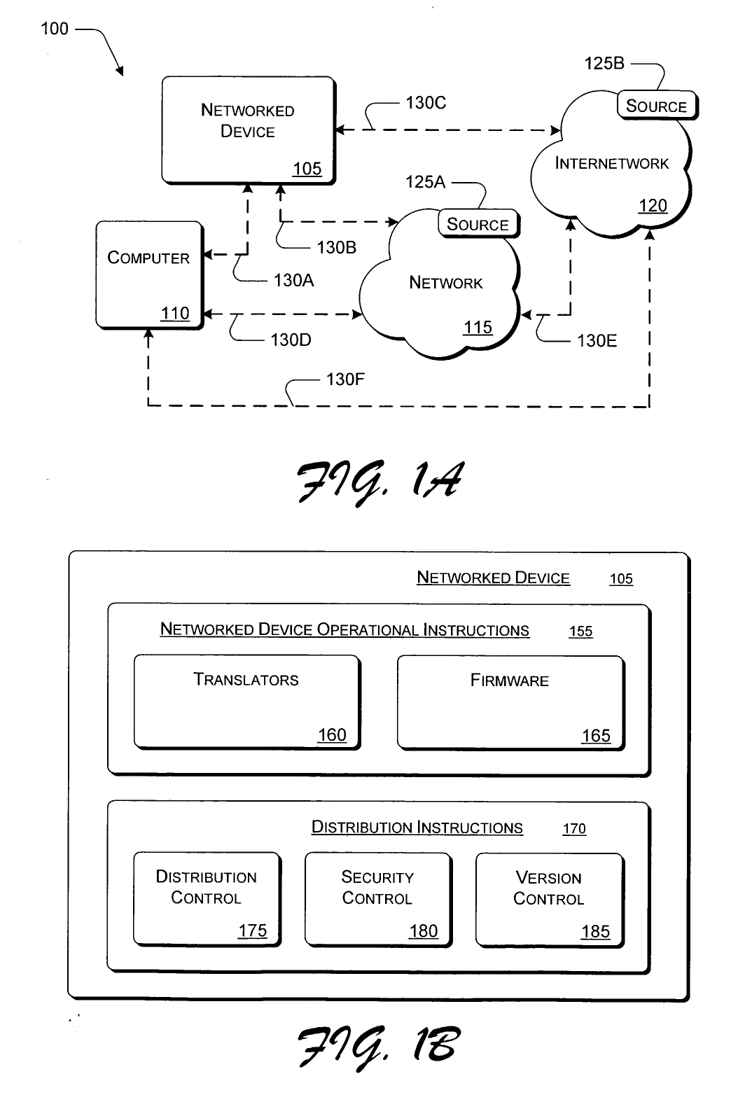

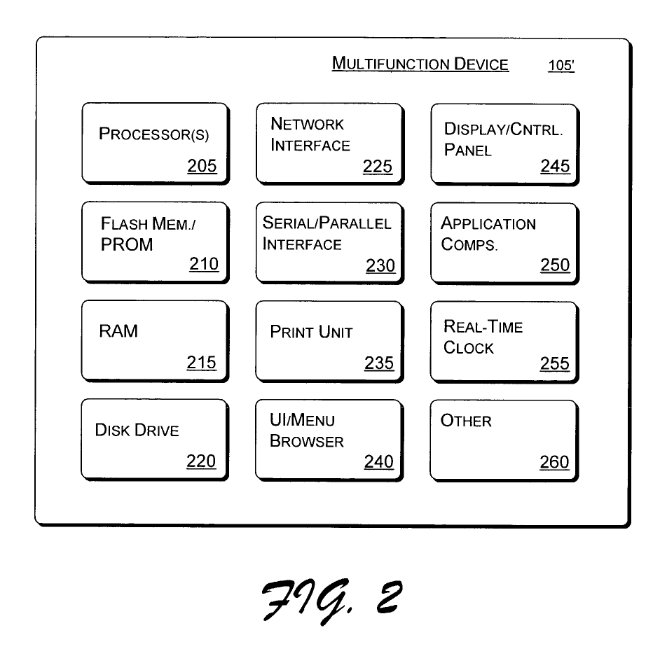

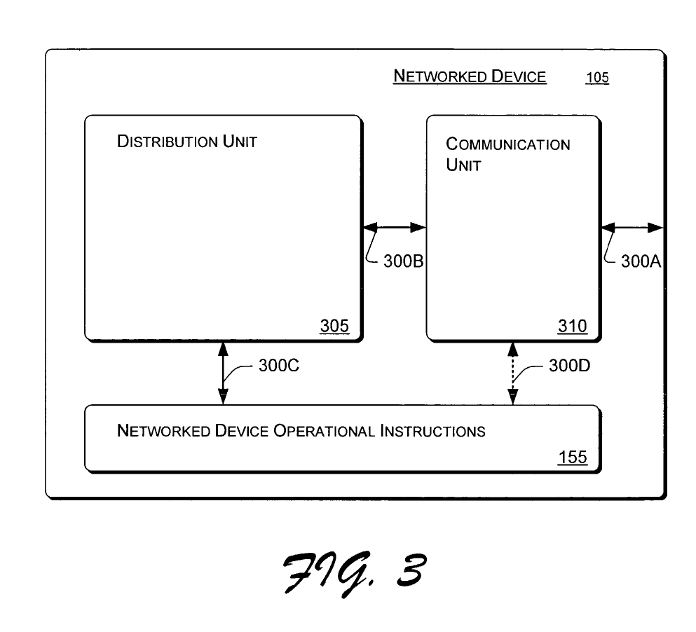

FIG. 1A illustrates a networked device in an exemplary environment with exemplary links to external communication points. The exemplary environment 100 includes a networked device 105. The networked device 105 may be a multifunction printing device, an imaging appliance in general, and so forth. The exemplary environment 100 may also include one or more of many different types of external communication points. These external communication points may include a computer 110, a network 115, an internetwork 120, and so forth.

The computer 110 may be a personal computer or similar. The network 115 may be a local/wide area network (LAN/WAN), a short-range wireless network (e.g., IEEE 802.11b, Bluetooth®, etc.), and so forth. The internetwork 120 may be the Internet, a wired/wireless telecommunications network, multiples or combinations thereof, and so forth. Each of the network 115 and the internetwork 120 may include a source 125A and 125B, respectively. The source 125 may include a file having (e.g., new, updated, etc.) operational instructions and the capability to interact with the networked device 105 to provide the operational instructions thereto. Each of the network 115 and the internetwork 120 may also include multiple such sources 125.

The networked device 105 may optionally be connected to one or more of these external communication points over links 130A, 130B, 130C, 130D, 130E, and 130F. These links 130A-130F may be realized, for example, using wireline or wireless links, depending on user preference and the options available for the given networked device 105 and the targeted external communication point. The networked device 105 may therefore be in communication with a source 125 over any one or more of the various links 130A-130F. For example, the networked device 105 may be in communication with the source 125B “directly” over the link 130C, “indirectly” through the network 115 and/or the computer 110, and so forth.

As another, more detailed example, another computer, server, or similar destination (such as the source 125A) may be attached to and/or be part of the network 115. The networked device 105 may then be able to communicate with the destination via the link 130B and the network 115 and/or via the link 130A, the computer 110, the link 130D, and the network 115. In the latter instance, the networked device 105 may communicate with the destination (such as the source 125A) through the network 115 via, and by way of example only, a wireless Bluetooth (® link (130A), a personal computer (110), and a wireline link (130D) that uses a modem-compatible protocol over a public telecommunications line.

FIG. 1B illustrates a networked device having exemplary instructions. The networked device 105 may include networked device operational instructions 155 and distribution instructions 170. The instructions of the networked device operational instructions 155 enable the networked device 105, at least partly, to accomplish the intended operations of the networked device 105. The networked device operational instructions 155 may include translators 160, firmware 165, and so forth. The translators 160 may be used to translate a given native format to a printable or other image-friendly format. The native format may be from a particular program such as a word processor, a spread sheet, a browser, a graphics application, and so forth.

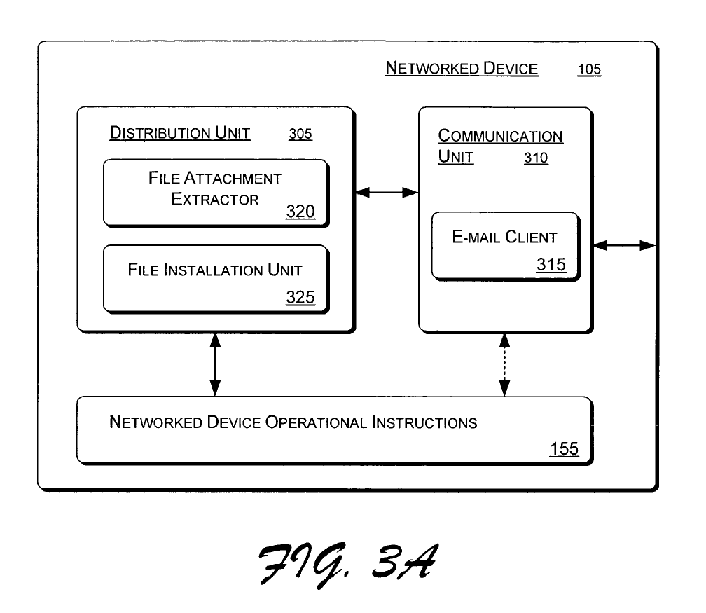

The networked device operational instructions 155 may also include the firmware 165. The firmware 165 may be used to cause the various aspects and components of the networked device 105 to execute and perform their respective functions so as to achieve the designated function(s) of the networked device 105. Exemplary aspects and components of an exemplary networked device, specifically a multifunction networked device 105′, are described below with reference to FIG. 2.

The distribution instructions 170 of the networked device 105 may include distribution control 175, security control 180, version control 185, and so forth. The distribution instructions 170 may be allocated to and dispersed among the various aspects and components of the networked device 105. The distribution control 175 controls the networked device 105 with respect to distributing new networked device operational instructions for the networked device operational instructions 155. The distribution control 175 may orchestrate communications with an external source 125 (from FIG. 1A), installation of the new networked device operational instructions, interplay between communication and installation functions, and so forth. For example, along with new networked device operational instructions, a command may be received at a networked device 105 that instructs the networked device 105 to install the new networked device operational instructions at some designated time (e.g., in the future). The distribution instructions 170 may follow such a command by causing the installation to commence at the designated time.

The security control 180 of the distribution instructions 170 controls any one or more of multiple possible security provisions applicable to and selected for the distribution of new networked device operational instructions. Such security provisions can include authentication, encryption, and so forth. For example, the remote source 125 can be authenticated by a digital security certificate or other authentication technique or scheme. As another example, the file(s) containing and/or composed of new networked device operational instructions may be encrypted by a public key/private key approach or other encryption technique or scheme. As yet another example, passwords may be used to ensure secure access to sources 125. In an exemplary FTP implementation, access to new networked device operational instructions that are located at a source 125 may require the logging into of a password-controlled FTP account.

The version control 185 of the distribution instructions 170 controls the accepting, requesting, and/or installing of new networked device operational instructions. For example, the version control 185 can prevent the networked device 105 from installing new networked device operational instructions if they are less advanced (e.g., older) than currently-installed networked device operational instructions. The installation prevention can be effectuated before or after offered new networked device operational instructions are stored within the networked device. In other words, the version control 185 may prevent the installation after the networked device acquires new networked device operational instructions or before the networked device acquires new networked device operational instructions.

Determining whether installation prevention is to be effected can be achieved, for example, by comparing a version indicator of current networked device operational instructions to a version indicator of offered networked device operational instructions. Additionally, the version control 185 may be set up to monitor new versions of networked device operational instructions, for example, by periodically or on some alternative schedule contacting an external source 125. When the version control 185 detects that a more current (or otherwise more advanced) version of networked device operational instructions is available, then the version control 185 can instigate or precipitate a distribution of these networked device operational instructions by notifying the distribution control 175.

FIG. 2 illustrates an exemplary (e.g., multifunction) networked device showing various exemplary logical blocks and components. A multifunction device, as the name implies, is a device capable of multiple functions which are related, but not necessarily limited, to one or more of the following functions: printing; copying; scanning, including image acquisition and text recognition; sending and receiving faxes; print media handling; and/or data communication, either by print media or e-media, such as via email or electronic fax. More generally, a multifunction device (or such a device with a single function) may be considered an imaging appliance. An imaging appliance, which is an example of a networked device, accepts, produces, and/or manipulates an image in electronic and/or hard copy form. In addition to a multifunction device, an imaging appliance can comprise a digital projector that displays and/or projects an image.

The multifunction device 105′ of FIG. 2, when it includes an interface connection, is an exemplary implementation of a networked device 105 (e.g., of FIGS. 1A and 1B). Although the description of FIG. 2 is directed primarily to the multifunction device 105′, at least portions of this description may pertain to other types of imaging appliances, as well as to networked devices in general. The multifunction device 105′ may include one or more processors 205, flash memory and/or programmable read-only memory (PROM) 210, and a random access memory (RAM) 215. The processor(s) 205 process various instructions to control the operation of the multifunction device 105′ and to communicate with other electronic and/or computing devices.

The multifunction device 105′ may also include read-only (non-erasable) memory (ROM) (not explicitly shown) that stores, for example, boot-level/initialization code, basic identification, and/or (e.g., unalterable) operational information, and so forth. The multifunction device 105′ may further include, for example, electrically programmable read-only memory (EPROM), electrically erasable programmable read-only memory (EEPROM), some other non-volatile (e.g., solid state) memory, and so forth.

The flash memory and/or PROM 210, for example, may store the networked device operational instructions 155 (of FIG. 1B), such as the translators 160 and the firmware 165. The multifunction device 105′ may alternatively or additionally store the networked device operational instructions 155 in a different type of writable or rewritable memory, including those enumerated above and further below. It should be noted that if there are multiple such memory components, they may be integrated on a single chip, be on separate chips, and so forth. Furthermore, although not explicitly shown, a system bus or busses may connect and interconnect the various illustrated logical blocks and components of the multifunction device 105′.

Contents of the flash memory and/or PROM 210 may be programmed and tested like software, and the contents may be originally included with the multifunction device 105′. An updating of such contents may be distributed after the multifunction device has been provided to the user, as is explained in detail herein. The flash memory and/or PROM 210 may be configured to coordinate operations of the other hardware within the multifunction device 105′ when, for example, the flash memory and/or PROM 210 stores programming constructs used to perform such operations. Such programming constructs are an example of networked device operational instructions 155 (of FIG. 1B).

The multifunction device 105′ may also include a disk drive 220 (and/or a hard drive or other large non-volatile memory storage), a network interface (e.g., adapter) 225, and a serial and/or parallel interface (e.g., adapter) 230. The disk drive 220 provides additional storage for data being printed, copied, scanned, and/or faxed, or other information maintained by or for the multifunction device 105′. Although the multifunction device 105′ is illustrated as having both the RAM 215 and the disk drive 220, a particular multifunction device 105′ may alternatively include either a RAM 215 or a disk drive 220, depending on the storage needs of the multifunction device 105′. It should be understood that the disk drive 220 (as well as the RAM 215) may alternatively be substituted with or complemented by another removable and rewritable storage medium, such as a flash memory card, a removable hard drive, a proprietary format (e.g., a ZIP® drive), and so forth.

The network interface 225 may provide a connection between the multifunction device 105′ and a data communication network (or a specific device connected over a network-type medium). The network interface 225 allows devices coupled to a common data communication network to send print jobs, faxes, menu data, and other information to multifunction device 105′ via the network. Similarly, the serial and/or parallel interface 230 may provide a data communication path directly between the multifunction device 105′ and another electronic and/or computing device. Although the multifunction device 105′ is illustrated as having the network interface 225 and the serial and/or parallel interface 230, a particular multifunction device 105′ may only include one such interface component. It should also be understood that the multifunction device 105′ may alternatively substitute or add another interface adapter type, such as a Universal Serial Bus (USB) interface adapter, an IEEE 1394 (“Firewire”) interface adapter, a wireless interface (e.g., Bluetooth®, IEEE 802.11b, wireless Local Area Network (LAN), etc.) adapter, and so forth.

The multifunction device 105′ may also include a print unit 235 that includes mechanisms arranged to selectively apply pigment (e.g., liquid ink, toner, etc.) to a print media such as paper, plastic, fabric, and the like in accordance with print data corresponding to a print job. For example, the print unit 235 may include a laser printing mechanism that selectively causes toner to be applied from toner container(s)/cartridge(s) to an intermediate surface of a drum or belt. The intermediate surface can then be brought in the proximity of a print media in a manner that causes the toner to be transferred to the print media in a controlled fashion. The toner on the print media can then be more permanently fixed to the print media, for example, by selectively applying thermal energy to the toner. Alternatively, the print unit 235 may include an ink jet printing mechanism that selectively causes liquid ink to be extracted from ink container(s) and ejected through print head nozzles and onto print media to form an intended pattern (e.g., text, pictures, etc.).

The print unit 235 may also be designed or configured to support duplex printing, for example, by selectively flipping or turning the print media as required to print (or copy, etc.) on both sides. There are many different types of print units available, and the print unit 235 may be composed of any one or more of these different types. The multifunction device 105′ may also optionally include a scanning unit (not shown) that can be implemented as an optical scanner to produce machine-readable image data signals that are representative of a scanned image, such as a photograph or a page of printed text. The image data signals produced by such a scanning unit can be used to reproduce the scanned image on a display device, such as a computer monitor or print media (e.g., via the print unit 235).

The multifunction device 105′ may also optionally include a user interface (UI) and/or menu browser 240 and a display and/or control panel 245. The UI and/or menu browser 240 allows a user of the multifunction device 105′ to navigate the device's menu structure (if any). A display aspect of the display and/or control panel 245 may be a graphical and/or textual display (including a liquid crystal display (LCD), a cathode ray tube (CRT), a plasma, a video, etc. screen) that provides information regarding, e.g., the status of the multifunction device 105′ and the current options available to a user through, e.g., a menu structure. A control aspect of the display and/or control panel 245, on the other hand, may be composed of indicators and/or a series of buttons, switches, or other selectable controls that are manipulated by a user of the multifunction device 105′.

The multifunction device 105′ may, and typically does, include application components 250 that provide a runtime environment in which software applications or components can run or execute. There are many different types of available runtime environments, which facilitate the extensibility of the multifunction device 105′ by allowing various interfaces to be defined that, in turn, allow the application components 250 to interact with the multifunction device 105′. Part or all of such application components 250 may form a portion of the networked device operational instructions 155 (of FIG. 1B).

The multifunction device 105′ may also include a real-time clock 255. The real-time clock 255 may be used, for example, to implement time-based version monitoring of the networked device operational instructions 155 (of FIG. 1B) by a version control 185. Other logic blocks and components may also be part of a multifunction device 105′, as indicated by the other block 260.

Upgrading firmware in a conventional printing device involves putting the printing device in a special mode and then sending the firmware upgrade as a single file to the printing device in the same manner as a print job. The new firmware completely replaces the old firmware. Upgrading translators in a conventional printing device, on the other hand, is even more arduous, for a translator upgrade entails physically delivering the translator upgrade to the printing device and then manually performing the upgrade. For example, a translator stored on a double inline memory module (DIMM) is replaced by physically swapping a first DIMM having an old translator with a second DIMM having a new translator. Furthermore, the process also entails manually registering the translator upgrade from the printing device.

In contradistinction to the above, a networked device as described herein may have new networked device operational instructions distributed thereto in the form of a file over one or more links. To effectuate the distribution, the networked device may acquire a file having installable networked device operational instructions from an external source at a communication unit of the networked device. A distribution unit of the networked device may then interact with the communication unit to install new networked device operational instructions from the acquired file into a networked device operational instructions space. The new networked device operational instructions may replace all or a portion. of the previous firmware and/or all or only some of the previous translators. The new networked device operational instructions may also add to the previous networked device operational instructions.

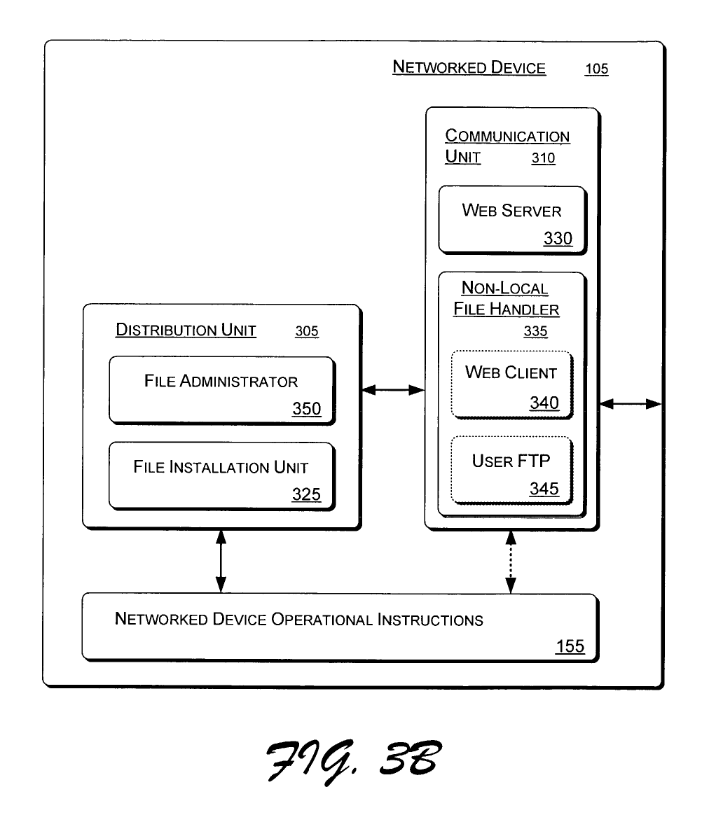

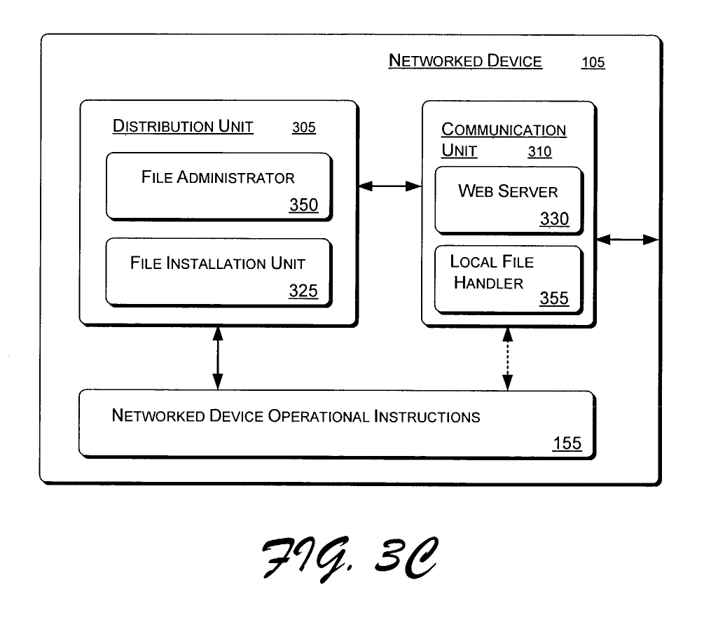

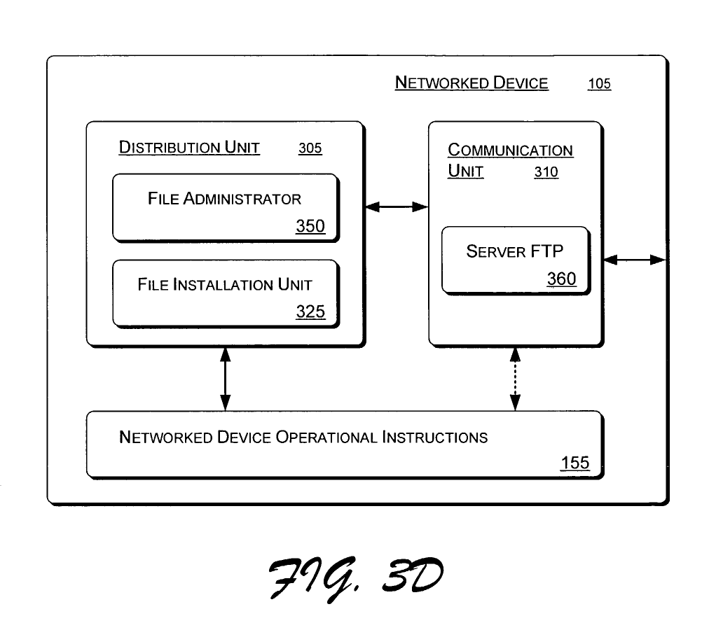

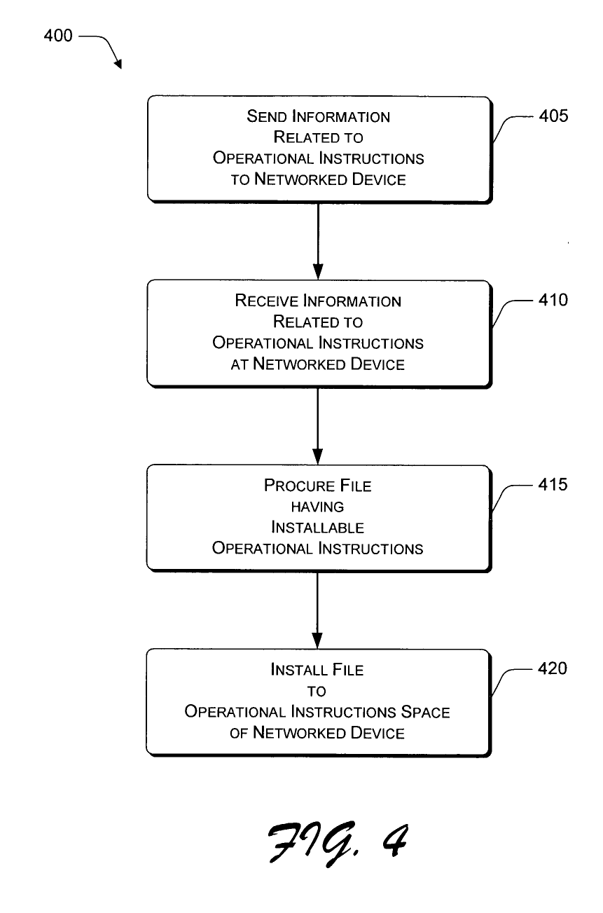

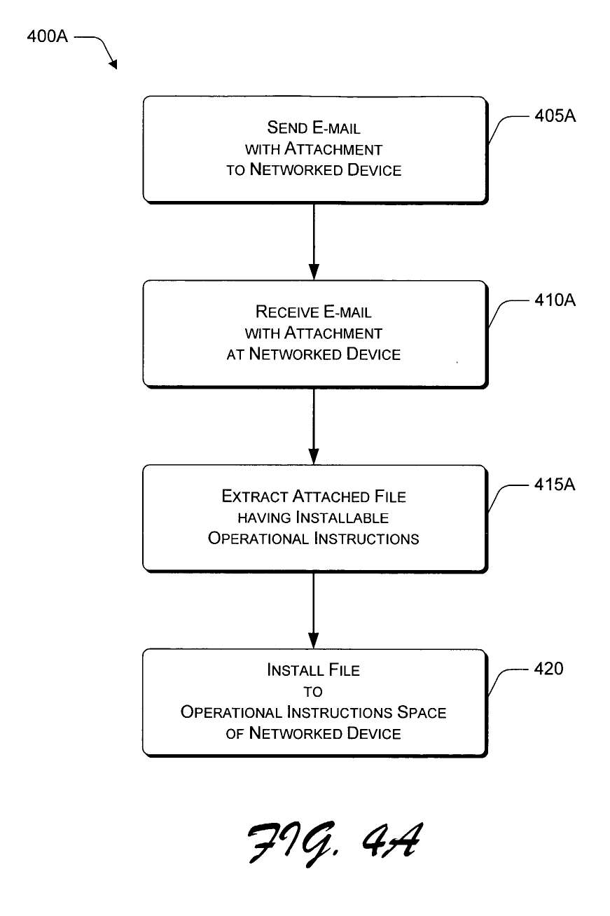

FIG. 3 illustrates an exemplary networked device having an operational instructions distribution capability. The exemplary networked device 105 includes a distribution unit 305, a communication unit 310, and networked device operational instructions 155. These elements interact to distribute new networked device operational instructions to the networked device 105. The new networked device operational instructions may be acquired, for example, over one or more links 130 (of FIG. 1A) from an external source such as a source 125.

The communication unit 310 may be used to acquire new networked device operational instructions over a (e.g., internal) link 300A via one or more of multiple approaches. These approaches include e-mail, non-local reference, local reference, receptive file transfer under FTP, and so forth, and they are explained further below. In performing communication functions, the communication unit 310 is thus capable of receiving from an external source information related to new operational instructions for the networked device. Such information related to new operational instructions may actually include new operational instructions.

The distribution unit 305 may be coupled to the communication unit 310 and may be capable of receiving the new operational instructions therefrom. The distribution unit 305 orchestrates the distribution of new networked device operational instructions. The orchestration may include controlling the communication unit 310 over a link 300B using all or part of the distribution instructions 170 (of FIG. 1B), which may be fully or partially part of the distribution unit 305. The control may therefore extend beyond pure file movement, for example, to security control 180 and version control 185. The orchestration by the distribution unit 305 may also include controlling the networked device operational instructions 155 over a link 300C.

The networked device operational instructions 155 may be considered as a networked device operational instructions space. In other words, it may be an area (e.g., of memory) that is designated, set aside, or otherwise capable of storing any operational instructions of the networked device. Thus, there may be a networked device operational instructions space prior to the existence of any networked device operational instructions 155 stored therein. This may occur if a networked device 105 is shipped without any networked device operational instructions 155 or perhaps only briefly if previous networked device operational instructions 155 are deleted prior to replacement with new networked device operational instructions 155.

After the communication unit 310 has acquired new networked device operational instructions, the distribution unit 305 further controls the networked device 105 to install the new operational instructions, assuming that the new operational instructions satisfy or have already satisfied any relevant security and version related requirements. The new operational instructions may add to, supplant, modify or otherwise affect current networked device operational instructions 155 (if any) in the networked device operational instructions space. The distribution unit 305 may effect the “movement” of the new operational instructions in a myriad of manners.

With respect to such “movement”, the distribution unit 305 is capable of receiving the new operational instructions from the communication unit 310 and providing them to the operational instructions space in a myriad of manners. Firstly, the “movement”, which may imply the installation, of the operational instructions to the networked device operational instructions 155 space may be effected by moving the new operational instructions through the distribution unit 305 over the links 300B and 300C. Secondly, the installation of the new operational instructions may be effected by moving them “directly” from the communication unit 310 to the networked device operational instructions 155 space over a link 300D. Thirdly, the installation may be effected by referencing a memory location (e.g., of RAM) to which the communication unit 310 may store or may have already stored new operational instructions and from which the networked device operational instructions 155 space can be loaded with the new operational instructions. This manner is additionally represented by the dashed appearance of the link 300D. Fourthly, incoming new networked device operational instructions may be stored to the networked device operational instructions 155 space directly without any (e.g., significant) intermediate storage thereof. Other manners may alternatively be employed.

FIG. 3A illustrates an exemplary networked device having an operational instructions distribution capability via e-mail. In the described email approach, the communication unit 310 includes an e-mail client 315. The e-mail client 315 may be a stand-alone e-mail program, a program that includes an e-mail feature, a browser capable of receiving and displaying text from emails (and receiving attachments thereof, too), any general program capable of receiving an e-mail with an attached file, and so forth. Once the e-mail client 315 has received an e-mail (e.g., from an external source 125 (of FIG. 1A)) with an attached file that has installable operational instructions, the distribution unit 305 may start or continue orchestrating the interaction between the units.

In the described e-mail approach, the distribution unit 305 includes a file attachment extractor 320 and a file installation unit 325. The file attachment extractor 320 extracts the file from the received e-mail for subsequent installation. The extraction may include accessing the received e-mail and separating the attached file therefrom, asking the e-mail client 315 for the attached file, reading the attached file from a memory location where the e-mail client stored it, and so forth. The file attachment extractor 320 may be part of a program, module, routine, etc. that also includes the e-mail client 315.

The file installation unit 325 is capable of installing the (installable and new) operational instructions into the networked device operational instructions 155 space (e.g., after acquiring the file from or through the file attachment extractor 320). The installation may be effectuated by adding the new operational instructions to previous operational instructions, by modifying previous operational instructions using the new operational instructions, by replacing the previous operational instructions with the new operational instructions, by inserting the new operational instructions into a previously-empty operational instructions space, and so forth.

FIG. 3B illustrates an exemplary networked device having an operational instructions distribution capability via a reference to a non-local source. In the described non-local source reference approach, the communication unit 310 includes a web server 330 and a non-local file handler 335. The web server 330 may be used by a manufacturer or other entity to reach the networked device 105. For example, an external source 125A or 125B (of FIG. 1A) may perform an interrupt/poll/etc. (or otherwise arbitrate for access to network 115 (e.g., a LAN/WAN)) or surf (or otherwise navigate over an internetwork 120 (e.g., the Internet)) to reach the web server 330 and thereby provide the communication unit 310 with a non-local reference. The non-local reference may be to the same source 125B that navigated to the web server 330 (if it was a source 125B that so navigated) or to a different source 125B (if it was either a source 125A or 125B that so navigated).

The non-local file handler 335 may be provided with the non-local reference either directly or indirectly from the web server 330 (e.g., under the guidance of the distribution control 175 (of FIG. 1B)). The non-local file handler 335 may include a web client 340 or a user FTP module 345 or both. The web client 340 may be a web browser or other program capable of accessing the referenced non-local source and acquiring a file therefrom. If the non-local reference is a uniform resource locator (URL) or similar, then the web client 340 may use the non-local reference to surf or otherwise navigate the internetwork 120 to reach the external source 125B of the non-local reference. The web client 340, after contacting the external source 125B, may retrieve a file having installable operational instructions by downloading the file.

On the other hand, if the non-local reference provided to the non-local file handler 335 is an FTP address, then the user FTP module 345 may be capable of initiating an FTP session. For example, the user FTP module 345 may include one or more of the following FTP components: a user interface, a user protocol interpreter (PI), and a user data transfer process (DTP). The user FTP module 345 may therefore be capable of initiating an FTP session with the external source 125B of the non-local reference. The user FTP module 345, after establishing an FTP session (e.g., a control connection and/or a data connection, etc.), may retrieve the file having installable operational instructions by transferring the file from the FTP address location to the networked device.

In the described non-local source reference approach, the distribution unit 305 may include a file administrator 350 and a file installation unit 325. The file administrator 350 is capable of interacting with the non-local file handler 335 and the file installation unit 325 to exchange the file between the former and the latter. The exchange may be effectuated over the links 300B and 300C (as indicated in FIG. 3), over the dashed link 300D, and so forth in any of the manners described above. In other words, the exchange may be direct or indirect. Thus, the file having the installable instructions may be moved in memory from the non-local file handler 335 (or elsewhere “in” the communication unit 310) to the file installation unit 325, a pointer to the file may be passed/copied/etc. from the non-local file handler 335 to the file installation unit 325, and so forth. The file installation unit 325 may perform the file installation of the (new) networked device operational instructions into the networked device operational instructions 155 space for the networked device 105 of FIG. 3B similarly to the file installation of the file installation unit 325 of FIG. 3A, as described above.

FIG. 3C illustrates an exemplary networked device having an operational instructions distribution capability via a reference to a local source. In the described local source reference approach, the communication unit 310 includes a web server 330 and a local file handler 355. The web server 330 may be used by a manufacturer, network manager, or other entity to reach the networked device 105. For example, an external source 125A or 125B (of FIG. 1A) may perform an interrupt/poll/etc. (or otherwise arbitrate for access to network 115 (e.g., a LAN/WAN)) or surf (or otherwise navigate over an internetwork 120 (e.g., the Internet)) to reach the web server 330 and thereby provide the communication unit 3 10 with a local reference.

The local reference may be to a same source 125A that navigated to the web server 330, to a different source 125A, to a hard drive or similar on the computer 110, and so forth. The local reference may be a pathname or other local network address to a location of a file having installable operational instructions. It should be noted that while the external source of the file that has a local reference may be the external source 125A, the external source that provides the local reference to the networked device may be the external source 125A or 125B.

The local file handler 355 may be provided with the local reference either directly or indirectly from the web server 330 (e.g., under the guidance of the distribution control 175 (of FIG. 1B)). Using the local reference (e.g., pathname, local network address, etc.), the local file handler 355 may access the location of the file having the installable operational instructions and seize the file. The file administrator 350 of the distribution unit 305 may acquire the file from the local file handler 355 or otherwise direct the file installation unit 325 to install the new operational instructions into the networked device operational instructions 155 space, as is described above with reference to FIGS. 3, 3A, and 3B.

FIG. 3D illustrates an exemplary networked device having an operational instructions distribution capability via receptive file transfer under a file transfer protocol (FTP). In the described receptive file transfer under an FTP approach, the communication unit 310 includes a server FTP module 360. The server FTP module 360 may be capable of acknowledging a request from an external (e.g., user FTP-based) source to initiate an FTP session. The server FTP module 360 may include one or more of the following FTP components to accomplish the server-side functions of an FTP transfer: a server PI and a server DTP. These components may be instrumental in performing server-side functions for establishing an FTP session (e.g., a control connection and/or a data connection, etc.) between the user-side of an FTP transfer and the server FTP module 360.

A user FTP at a communication point such as an external source 125 may therefore be able to transfer a file having operational instructions to the server FTP module 360. Thus, the server FTP module 360 of the communication unit 310 may receive the file as transferred thereto under an FTP. The file administrator 350 of the distribution unit 305 may acquire the file from the server FTP module 360 or otherwise direct the file installation unit 325 to install the new operational instructions into the networked device operational instructions 155 space, as is described above with reference to FIGS. 3, 3A, and 3B.

A networked device 105 (e.g., of FIGS. 1-3) may therefore enjoy updated networked device operational instructions 155 by participating in a distribution of new networked device operational instructions into a networked device operational instructions space. Such a distribution may be effectuated, at least in part, using one or more of multiple described exemplary approaches. The above-described approaches are for networked devices 105 (e.g., of FIG. 3+) that may utilize a communication unit 310 and a distribution unit 305, and the approaches may include an e-mail approach (FIG. 3A), a non-local reference approach (FIG. 3B), a local reference approach (FIG. 3C), and a receptive file transfer under an FTP approach (FIG. 3D).

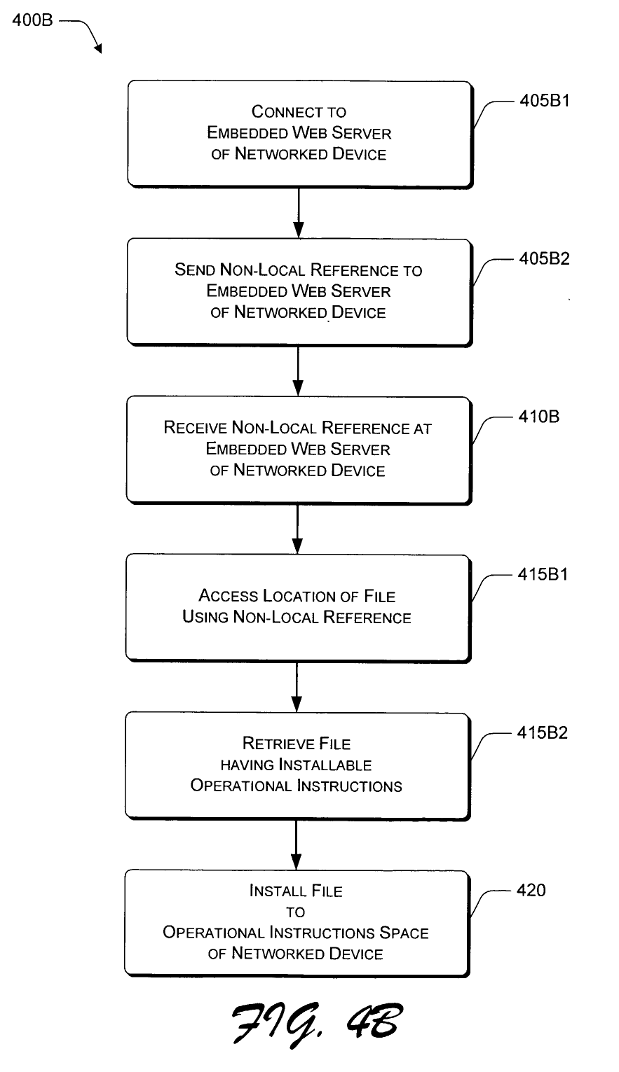

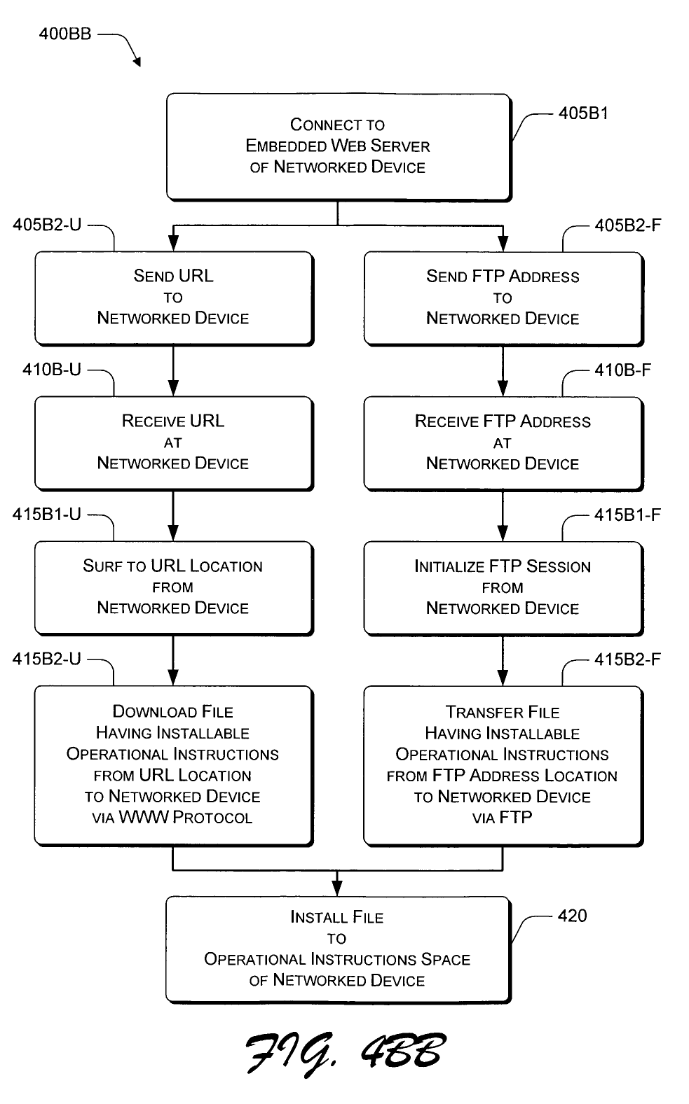

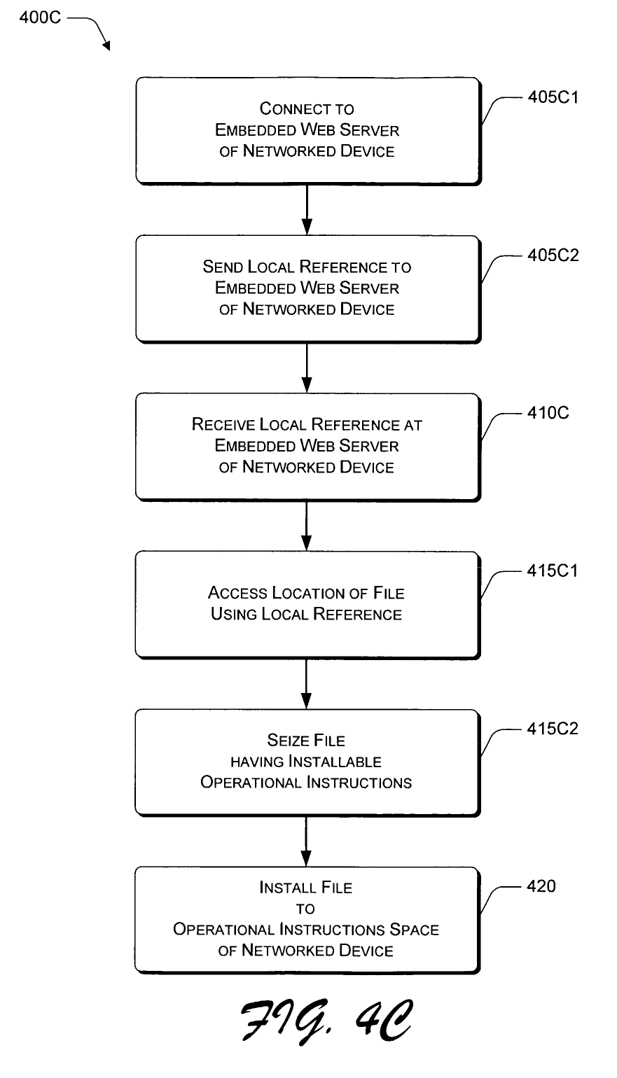

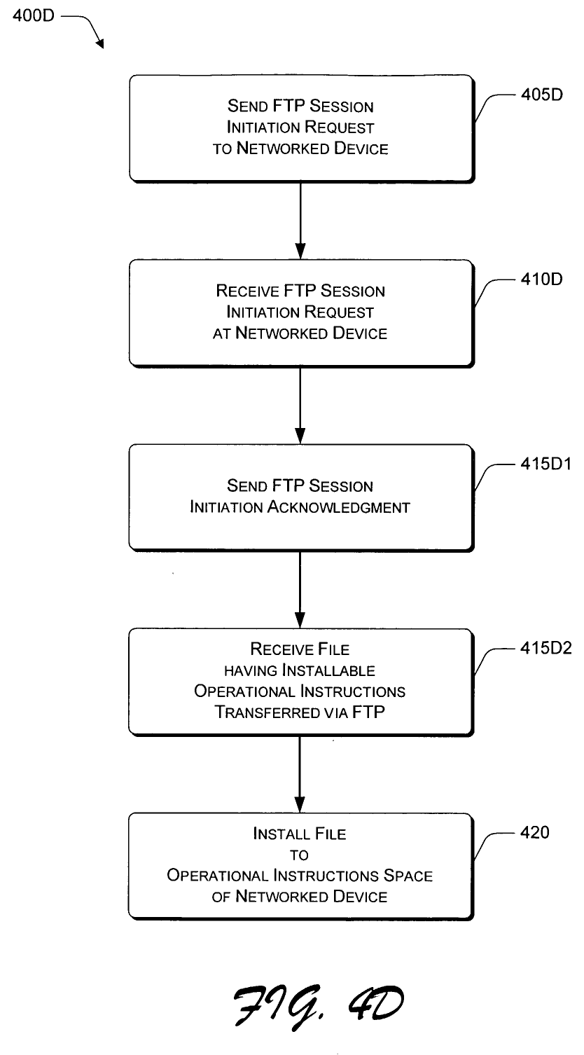

On the other hand, the below described methodological approaches (e.g., of FIG. 4+) are illustrated by flowcharts that may include an e-mail approach (FIG. 4A), a non-local reference approach (FIGS. 4B and 4BB), a local reference approach (FIG. 4C), and a receptive file transfer under an FTP approach (FIG. 4D). It should be understood, however, that the unit-based approaches described above and the method-based approaches described below may have interrelated, interchangeable, overlapping, and/or similar features, components, aspects, functions, and so forth and that the descriptions of one may illuminate the other.

FIG. 4 illustrates an exemplary method in flowchart form for distributing operational instructions to a networked device. The flowchart 400 includes four general actions 405, 410, 415, and 420 for distributing networked device operational instructions. An action 405 comprises sending information that is related to operational instructions to a networked device. The information may be sent from a communication point external to the networked device. An action 410 comprises receiving the information that is related to operational instructions at the networked device. An action 415 comprises procuring a file that has installable operational instructions, and an action 420 comprises installing the file to an operational instructions space of the networked device.

The numeric element indicators 405-415 and 420 are used to denote the actions illustrated in FIG. 4. Similarly, the alphanumeric element indicators 405A-415A and 420 are used to denote the actions illustrated in FIG. 4A, which is described below. Accordingly, the element indicators present in FIGS. 4A-4D relate to the element indicators 405-420 present in FIG. 4. There is thus a correspondence between the numeric element indicators in FIG. 4 and the numeric portion of the alphanumeric indicators in FIGS. 4A-4D. For example, the actions 415B1 and 415B2 (of FIG. 4B) correspond to the action 415 (of FIG. 4). Hence, as is apparent from the description of FIG. 4B below, the actions of accessing (415B1) and retrieving (415B2) may be effectuated to implement the action of procuring (415) using a non-local reference approach to distributing networked device operational instructions as is described with reference to FIG. 4B.

FIG. 4A illustrates an exemplary method in flowchart form for distributing operational instructions to a networked device via e-mail. The flowchart 400A includes four actions 405A, 410A, 415A, and 420. An action 405A comprises sending an e-mail with an attachment to a networked device. The e-mail may be sent from a communication point external to the networked device, and the attachment may be a file including installable operational instructions. An action 410A comprises receiving the e-mail with the attachment (e.g., the file) at the networked device. An action 415A comprises extracting the attached file that has the installable operational instructions from the e-mail. And an action 420 comprises installing the file to the operational instructions space of the networked device.

FIG. 4B illustrates an exemplary method in flowchart form for distributing operational instructions to a networked device via non-local reference. The flowchart 400B includes six actions 405B1, 405B2, 410B, 415B1, 415B2, and 420 from a general perspective for distributing networked device operational instructions using a non-local reference. An action 405B1 comprises connecting to an embedded web server of a networked device, and an action 405B2 comprises sending a non-local reference to the embedded web server of the networked device. The non-local reference may be sent from a communication point external to the networked device, and the non-local reference may reference a file having installable operational instructions that is present, for example, at a source on an internetwork. An action 410B comprises receiving the non-local reference at the embedded web server of the networked device.

In an effort to procure the file, an action 415B 1 comprises accessing the location of the file at the external communication point using the non-local reference. An action 415B2 comprises retrieving the file that has the installable operational instructions to the networked device from the external communication point. Once the file is at or arriving at the networked device, an action 420 comprises installing the file to an operational instructions space of the networked device.

FIG. 4BB illustrates another exemplary method in flowchart form for distributing operational instructions to a networked device via non-local reference. The flowchart 400BB includes ten actions 405B1, 405B2-U, 405B2-F, 410B-U, 410B-F, 415B1-U, 415B1-F, 415B2-U, 415B2-F, and 420 from the specific perspectives of a URL (actions having the “-U” extension) and an FTP address (actions having the “-F” extension). The action 405B1 comprises connecting to the embedded web server of the networked device from an external communication point. An action 405B2-U comprises sending a URL to the networked device, and an action 405B2-F comprises sending an FTP address to the networked device. The URL and/or the FTP address may be sent to the networked device from the external communication point.

At the networked device, an action 410B-U comprises receiving the URL at the networked device, and an action 410B-F comprises receiving the FTP address at the networked device. After receiving the URL and/or the FTP address, an action 415B1-U comprises surfing (e.g., navigating) to the URL location from the networked device, and an action 415B1-F comprises initializing an FTP session from the networked device at a location of the FTP address. The location may hold or otherwise be associated with the file that has installable operational instructions. After surfing to the URL location, an action 415B2-U comprising downloading the file having installable operational instructions from the URL location to the networked device via a world wide web (WWW) protocol may be performed. And after initializing the FTP session, an action 415B2-F comprising transferring the file having installable operational instructions from the FTP address location to the networked device via the same FTP used to initialize the session may be performed. Once the file is at or arriving at the networked device via either (or any other) protocol, an action 420 comprising installing the file to an operational instructions space of the networked device may be performed.

FIG. 4C illustrates an exemplary method in flowchart form for distributing operational instructions to a networked device via local reference. The flowchart 400C includes six actions 405C1, 405C2, 410C, 415C1, 415C2, and 420. An action 405C1 comprises connecting to an embedded web server of a networked device, and an action 405C2 comprises sending a local reference to the embedded web server of the networked device. The local reference may be sent from a communication point external to the networked device, and the local reference may reference a file having installable operational instructions that is present, for example, at a source on an attached computer or a local network. An action 410C comprises receiving the local reference at the embedded web server of the networked device.

In an effort to procure the file, an action 415C1 comprises accessing the location of the file at the external communication point using the local reference. An action 415C2 comprises seizing the file that has the installable operational instructions for the networked device from the external communication point. Once the file is at or arriving at the networked device, an action 420 comprises installing the file to an operational instructions space of the networked device.

FIG. 4D illustrates an exemplary method in flowchart form for distributing operational instructions to a networked device via receptive file transfer under an FTP. The flowchart 400D includes five actions 405D, 410D, 415D1, 415D2, and 420. An action 405D comprises sending an FTP session initiation request to a networked device. The FTP session initiation request may be sent from a communication point external to the networked device. An action 410D comprises receiving the FTP session initiation request at the networked device. In response, an action 415D1 comprises sending an FTP session initiation acknowledgment.

The external communication point, which is the source of a file having operational instructions, initiates and leads (or otherwise controls) the FTP session. The external communication point thus causes the transfer of the file to the networked device to begin under an FTP once the FTP session is established. Hence, an action 415D2 comprises receiving a file that has installable operational instructions as transferred from an external source via FTP. After at least a portion of the file is at the networked device, an action 420 comprises installing the file to an operational instructions space of the networked device.

Although implementation(s) of apparatuses, methods, systems, and arrangements have been illustrated in the accompanying Drawings and described in the foregoing Detailed Description, it will be understood that the present invention is not limited to the implementation(s) explicitly disclosed, but is capable of numerous rearrangements, modifications, substitutions, etc. without departing from the spirit and scope set forth and defined by the following claims.

What is claimed is:

1. A networked device configured to perform actions comprising:
receiving information related to operational instructions for the networked device;
procuring a file having installable operational instructions responsive to the information; and
installing the file to an operational instructions space of the networked device.

2. The networked device of claim 1, wherein:
the receiving action comprises the action of receiving an e-mail having the file attached thereto; and
the procuring action comprises the action of extracting the file from the e-mail.

3. The networked device of claim 1, wherein:
the receiving action comprises the action of receiving a non-local reference; and
the procuring action comprises the actions of:
accessing a location of the file using the non-local reference; and
retrieving the file from the location.

4. The networked device of claim 3, wherein the receiving action further comprises the action of:
receiving the non-local reference at an embedded web server of the networked device.

5. The networked device of claim 3, wherein:
the receiving action further comprises the action of receiving a uniform resource locator (URL), the non-local reference comprising the URL; and
the accessing and retrieving actions respectively comprise the actions of:
surfing to the location of the file using the URL; and
downloading the file from the location via a world wide web protocol.

6. The networked device of claim 3, wherein:
the receiving action further comprises the action of receiving a file transfer protocol (FTP) address, the non-local reference comprising the FTP address; and
the accessing and retrieving actions respectively comprise the actions of:
initializing an FTP session from the networked device to the location using the FTP address; and
transferring the file from the location to the networked device via FTP.

7. The networked device of claim 1, wherein:
the receiving action comprises the action of receiving a local reference; and
the procuring action comprises the actions of:
accessing a location of the file using the local reference; and
seizing the file from the location.

8. The networked device of claim 7, wherein the receiving action further comprises the action of:
receiving the local reference at an embedded web server of the networked device.

9. The networked device of claim 1, wherein:
the receiving action comprises the action of receiving a file transfer protocol (FTP) session initiation request; and
the procuring action comprises the actions of:
sending an FTP session initiation acknowledgment; and
receiving the file as transferred to the networked device via FTP.

10. The networked device of claim 1, wherein the networked device is configured to further perform an action comprising:
comparing a version of offered operational instructions with a version of current operational instructions of the networked device; and
wherein the action of installing is effectuated only if the version of offered operational instructions is more advanced than the version of current operational instructions of the networked device.

11. The networked device of claim 10, wherein the action of procuring is effectuated only if the version of offered operational instructions is more advanced than the version of current operational instructions of the networked device.

12. The networked device of claim 1, wherein at least one of the actions of receiving and procuring includes a security-related protocol having at least one condition; and
wherein the action of installing is effectuated only if the at least one condition of the security-related protocol is satisfied.

13. The networked device of claim 12, wherein the action of procuring is effectuated only if the at least one condition of the security-related protocol is satisfied.

14. A networked device, comprising:
an operational instructions space, the operational instructions space capable of storing operational instructions of the networked device;
a communication unit, the communication unit capable of receiving from an external source information related to new operational instructions for the networked device;
a distribution unit, the distribution unit coupled to the communication unit and capable of receiving new operational instructions from the communication unit and providing the new operational instructions to the operational instructions space.

15. The networked device of claim 14, wherein:
the communication unit comprises an e-mail client, the e-mail client capable of receiving an e-mail with an attached file having the new operational instructions; and
the distribution unit comprises:
a file attachment extractor, the file attachment extractor capable of extracting the attached file; and
a file installation unit, the file installation unit capable of installing the attached file to the operational instructions space.

16. The networked device of claim 14, wherein:
the communication unit comprises:
a web server, the web server capable of receiving a non-local reference of a file having the new operational instructions; and
a non-local file handler, the non-local file handler capable of accessing a location of the file using the non-local reference and retrieving the file from the location; and
the distribution unit comprises:
a file installation unit, the file installation unit capable of installing the file to the operational instructions space; and
a file administrator, the file administrator capable of interacting with the non-local file handler and the file installation unit to exchange the file therebetween.

17. The networked device of claim 16, wherein the non-local reference comprises at least one of (i) a uniform resource locater (URL) and (ii) a file transfer protocol (FTP) address; and wherein the location comprises a location on an internetwork.

18. The networked device of claim 16, wherein the non-local file handler comprises a web client, the web client capable of pointing to the location of the file using the non-local reference and downloading the file from the location.

19. The networked device of claim 16, wherein the non-local file handler comprises a user file transfer protocol (FTP) module, the user FTP module capable of initializing an FTP session with the location of the file using the non-local reference and transferring the file from the location to the user FTP module.

20. The networked device of claim 14, wherein:
the communication unit comprises:
a web server, the web server capable of receiving a local reference of a file having the new operational instructions; and
a local file handler, the local file handler capable of accessing a location of the file using the local reference and seizing the file from the location; and
the distribution unit comprises:
a file installation unit, the file installation unit capable of installing the file to the operational instructions space; and
a file administrator, the file administrator capable of interacting with the local file handler and the file installation unit to exchange the file therebetween.

21. The networked device of claim 20, wherein the local reference comprises a pathname; and wherein the location comprises a location on at least one of (i) a local network, (ii) a computer directly attached to the networked device, and (iii) a non-volatile storage of the networked device.

22. The networked device of claim 14, wherein:
the communication unit comprises a server file transfer protocol (FTP) module, the server FTP module capable of receiving an FTP session initiation request, sending an FTP session initiation acknowledgment, and receiving a file having the new operational instructions as transferred from the external source; and
the distribution unit comprises:
a file installation unit, the file installation unit capable of installing the file to the operational instructions space; and
a file administrator, the file administrator capable of interacting with the server FTP module and the file installation unit to exchange the file therebetween.

23. The networked device of claim 22, wherein the file administrator is capable of exchanging the file between the server FTP module and the file installation unit by causing the server FTP module to store the file to a memory and by causing the file installation unit to read the file from the memory.

24. The networked device of claim 14, wherein the networked device comprises an imaging appliance.

25. The networked device of claim 24, wherein the imaging appliance is adapted to perform at least one function selected from the group comprising: scanning, faxing, copying, printing, displaying, and projecting.

26. The networked device of claim 14, wherein the distribution unit comprises a file installation unit; the file installation unit capable of installing the new operational instructions into the operational instructions space of the networked device, the operational instructions space of the networked device being previously-empty.

27. The networked device of claim 14, wherein the distribution unit comprises a file installation unit; the file installation unit capable of installing the new operational instructions into the operational instructions space of the networked device by replacing old operational instructions in the operational instructions space of the networked device with the new operational instructions.

28. The networked device of claim 14, wherein the distribution unit comprises a file installation unit; the file installation unit capable of installing the new operational instructions into the operational instructions space of the networked device by adding the new operational instructions to old operational instructions in the operational instructions space of the networked device, the old operational instructions being thereby amended.

29. The networked device of claim 14, wherein the operational instructions space comprises at least one of translators and firmware.

30. The networked device of claim 14, wherein the capability of receiving new operational instructions of the distribution unit comprises a capability of receiving a pointer referencing the new operational instructions.

31. The networked device of claim 14, further comprising:
security control instructions; the security control instructions capable of preventing at least one of acquiring the new operational instructions and installing the new operational instructions if a predetermined condition is not satisfied.

32. The networked device of claim 31, wherein the predetermined condition is related to at least one of authentication and encryption.

33. The networked device of claim 14, further comprising:
version control instructions; the version control instructions adapted to manage a version of installed operational instructions of the operational instructions space.

34. The networked device of claim 33, wherein the version control instructions are capable of preventing at least one of acquiring the new operational instructions and installing the new operational instructions if the version of the new operational instructions is not more advanced than a current version of current operational instructions.

35. The networked device of claim 33, wherein the version control instructions are capable of performing, in conjunction with the communication unit, an interrogation with the external source to determine if more advanced operational instructions are available.

36. One or more electronically-accessible media storing electronically-executable instructions that are capable of configuring a networked device to perform actions comprising:
receiving information related to operational instructions for the networked device;
procuring a file having installable operational instructions responsive to the information; and
installing the file to an operational instructions space of the networked device.

37. The one or more electronically-accessible media of claim 36, wherein:
the receiving action comprises the action of receiving an e-mail having the file attached thereto; and
the procuring action comprises the action of extracting the file from the e-mail.

38. The one or more electronically-accessible media of claim 36, wherein:
the receiving action comprises the action of receiving a non-local reference; and
the procuring action comprises the actions of:
accessing a location of the file using the non-local reference; and
retrieving the file from the location.

39. The one or more electronically-accessible media of claim 36, wherein:
the receiving action comprises the action of receiving a local reference; and
the procuring action comprises the actions of:
accessing a location of the file using the local reference; and
seizing the file from the location.

40. The one or more electronically-accessible media of claim 36, wherein:
the receiving action comprises the action of receiving a file transfer protocol (FTP) session initiation request; and
the procuring action comprises the actions of:
sending an FTP session initiation acknowledgment; and
receiving the file as transferred to the networked device via FTP.

41. The one or more electronically-accessible media of claim 36, wherein the operational instructions comprise at least one of translators and firmware.

42. An arrangement for distribution of operational instructions, comprising:
receiving means for receiving information related to operational instructions;
procuring means for procuring a file having installable operational instructions responsive to the information; and
installing means for installing the file to an operational instructions space.

43. The arrangement of claim 42, wherein:
the receiving means comprises means for receiving an e-mail having the file attached thereto; and
the procuring means comprises means for extracting the file from the e-mail.

44. The arrangement of claim 42, wherein:
the receiving means comprises means for receiving a non-local reference; and
the procuring means comprises:
means for accessing a location of the file using the nonlocal reference; and
means for retrieving the file from the location.

45. The arrangement of claim 44, wherein the receiving means further comprises:
means for receiving the non-local reference at an embedded web server.

46. The arrangement of claim 44, wherein:
the receiving means further comprises means for receiving a uniform resource locator (URL), the non-local reference comprising the URL;
the means for accessing comprises means for surfing to the location of the file using the URL; and
the means for retrieving comprises means for downloading the file from the location via a world wide web protocol.

47. The arrangement of claim 44, wherein:
the receiving means further comprises means for receiving a file transfer protocol (FTP) address, the non-local reference comprising the FTP address; and
the means for accessing comprises means for initializing an FTP session to the location using the FTP address; and
the means for retrieving comprises means for transferring the file from the location via FTP.

48. The arrangement of claim 42, wherein:
the receiving means comprises means for receiving a local reference; and
the procuring means comprises:
means for accessing a location of the file using the local reference; and
means for seizing the file from the location.

49. The arrangement of claim 48, wherein the receiving means further comprises:
means for receiving the local reference at an embedded web server.

50. The arrangement of claim 42, wherein:
the receiving means comprises means for receiving a file transfer protocol (FTP) session initiation request; and
the procuring means comprises:
means for sending an FTP session initiation acknowledgment; and
means for receiving the file as transferred via FTP.

51. The arrangement of claim 42, wherein the arrangement comprises an imaging appliance.

52. A method for distribution of operational instructions, comprising:
receiving information related to operational instructions; procuring a file having installable operational instructions responsive to the information; and
installing the file to an operational instructions space.

53. The method of claim 52, wherein:
the receiving action comprises the action of receiving an e-mail having the file attached thereto; and
the procuring action comprises the action of extracting the file from the e-mail.

54. The method of claim 52, wherein:
the receiving action comprises the action of receiving a non-local reference; and
the procuring action comprises the actions of:
accessing a location of the file using the non-local reference; and
retrieving the file from the location.

55. The method of claim 52, wherein:
the receiving action comprises the action of receiving a local reference; and
the procuring action comprises the actions of:
accessing a location of the file using the local reference; and
seizing the file from the location.

56. The method of claim 52, wherein:
the receiving action comprises the action of receiving a file transfer protocol (FTP) session initiation request; and
the procuring action comprises the actions of:
sending an FTP session initiation acknowledgment; and
receiving the file as transferred to the networked device via FTP.

57. The method of claim 52, further comprising:
sending the information related to operational instructions; and
wherein the actions of receiving, procuring, and installing are performed by a networked device; and wherein the action of sending is performed by a communication point external to the networked device.

58. The method of claim 52, further comprising:
sending the information related to operational instructions; and
wherein the sending action comprises at least one of the following action or actions:
(i) sending an e-mail having the file attached thereto;
(ii) connecting to an embedded web server; and
sending a non-local reference to the embedded web server;
(iii) sending a local reference; and
(iv) sending a file transfer protocol (FTP) session initiation request.
